(19) United States
(12) Patent Application Publication
(10) Pub. No.: US 2026/0350916 A1
(43) Pub. Date: Nov. 5, 2026

(54) Interactive Three-Dimensional Environment with Degree of Freedom Constrained Camera Motion and Wall Dissolve

(71) Applicant: Bonfire Studios, Inc., Irvine, CA (US)

(72) Inventors: Jeremy Scott Craig, Placentia, CA (US); Nicholas Albert Brancaccio, Piedmont, CA (US); Shao Loon Dominic Qwek, Irvine, CA (US); Szymon Swistun, Belmont, CA (US)

(21) Appl. No.: 19/539,795

(22) Filed: Feb. 13, 2026

Related U.S. Application Data
(60) Provisional application No. 63/758,954, filed on Feb. 14, 2025.

(51) Int. Cl. G06T 15/20; A63F 13/5255; G06T 15/06; G06T 19/00

(52) U.S. Cl. CPC G06T 15/20; A63F 13/5255; G06T 15/06; G06T 19/00

(57) ABSTRACT

A virtual camera has a predetermined height and pitch angle in a virtual environment. A user may rotate the virtual camera at a fixed distance around a point of focus (e.g., a character being controlled by the user in the virtual environment). To prevent walls and other large objects in the environment from obscuring the user’s view, a wall dissolve algorithm is used to dynamically determine whether a segment of a wall (or other large object) is obscuring a portion of the environment that should be visible to the user’s character.

### CROSS-REFERENCE TO RELATED APPLICATIONS

This Application claims the benefit of U.S. Provisional Patent Application No. 63/758,954, filed on Feb. 14, 2025, which is incorporated by reference.

### BACKGROUND

### 1. TECHNICAL FIELD

The subject matter described relates generally to interactive three-dimensional (3D) environments and, in particular, to providing views of such environments.

### 2. BACKGROUND INFORMATION

Interactive 3D environments (e.g., game worlds) are experienced via views of the environment that are rendered from the viewpoint of a virtual camera located within the environment. Depending on the use case, different decisions can be made on where to position the camera and how much control to provide the user over the camera. Most existing systems fall broadly into one of two categories. In one category, the camera position is predetermined by the developer or toggled by the user between a small number of predetermined options. This provides the develop a great deal of control over how users experience the environment but can feel limiting to users and lead to situations where the predetermined view or views do not enable users to see desired portions of the environment. In the second category, users are provided complete control (e.g., with seven degrees of freedom) or close to complete control (e.g., with six degrees of freedom). This can help with user immersion in the environment but requires a significant number of input controls. This latter point can be a problem in scenarios where the user has a limited number of input controls (e.g., when interacting with the environment using a game controller) as each input control used for controlling the camera cannot then be used for controlling other aspects of interaction with the environment.

Furthermore, in cases where the camera positions are not predetermined, problems can arise where the camera view is blocked by elements of the environment. For example, if the camera is pointed at a user’s avatar or character but positioned behind a wall, the wall will block the user’s view of their avatar or character. Some existing solutions for cameras with high degrees of freedom of motion address this by preventing the camera from moving into or behind objects, but this can lead to undesirable views as well, such as an extreme close-up view of the user’s avatar or character when the user is in fact trying to look at an object some distance away.

### SUMMARY

Disclosed are various techniques to address the above and other problems. In one embodiment, a virtual camera having a predetermined height and pitch angle in a virtual environment, but which the user may rotate at a fixed distance around a point of focus, is used to provide consistent views of a virtual environment. The point of focus may be a character being controlled by the user in the virtual environment. Thus, the user may directly control the orientation of the camera around their character while control its translational position indirectly by moving their character in the environment.

In some embodiments, to prevent walls and other large objects in the environment from obscuring the user’s view, a wall dissolve algorithm is used to dynamically determine whether a segment of a wall (or other large object) is obscuring a portion of the environment that should be visible to the user’s character and, if so, “dissolve” that segment of the wall (e.g., by replacing it with a stump indicating the footprint of the wall segment).

Various aspect of the virtual environment can be tailored to provide improved experiences in view of the limited camera control provided to users. For example, environment, character, and visual effect art can all be authored to be optimized for being viewed from the predetermined height and angle of the virtual camera, but with any orientation. Similarly, the virtual environment may be designed to have a single level (e.g., without steps or ramps) to make the distance away from the character that is visible constant regardless of the character’s position in the environment. As another example, items (e.g., power ups, quest items, etc.) that the user’s character may pick up or otherwise interact with may be dynamically rotated to always face the same direction relative to the camera so they can be easily identified from any camera position.

### BRIEF DESCRIPTION OF THE DRAWINGS

FIG. 1 is a block diagram of a networked computing system suitable for providing a shared virtual environment, according to one embodiment.

FIG. 2 is a block diagram of the server of FIG. 1, according to one embodiment.

FIG. 3 is a block diagram of a client device of FIG. 1, according to one embodiment.

FIGS. 4A and 4B illustrate the constrained motion of a camera relative to a character, according to one embodiment.

FIGS. 5A, 5B,and 5C, illustrate a wall dissolve algorithm being applied as a camera is rotated around a character, according to one embodiment.

FIGS. 6A, 6B, and 6C, illustrate a wall dissolve algorithm that uses sensors around a character to define a cone within which walls are considered for dissolving, according to one embodiment.

FIG. 7 is a flowchart illustrating a method for generating a view of a virtual environment with an obstructing wall (or other large object) removed, according to one embodiment.

FIG. 8 is a block diagram illustrating an example of a computer suitable for use in the networked computing system of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### OVERVIEW

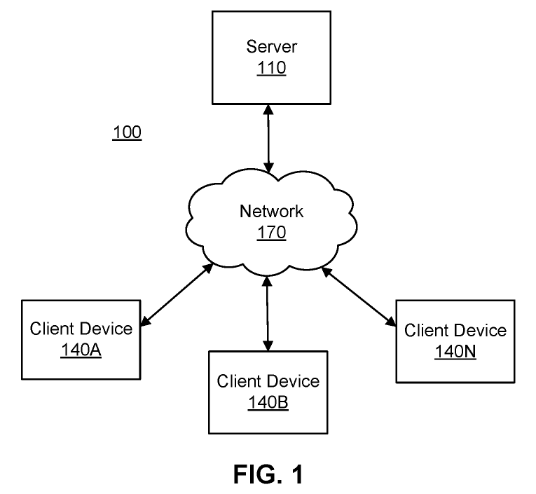

FIG. 1 illustrates one embodiment of a networked computing system 100 suitable for providing a shared virtual environment. In the embodiment shown, the networked computing system 100 includes a server 110 and a set of client devices 140, all connected via a network 170. In the illustrated example, the set of client devices 140 includes a first client device 140A, and second client device 140B, and an Nth client device 140N, but the set can include any number of client devices. In other embodiments, the networked computing system 100 includes different or additional elements. In addition, the functions may be distributed among the elements in a different manner than described.

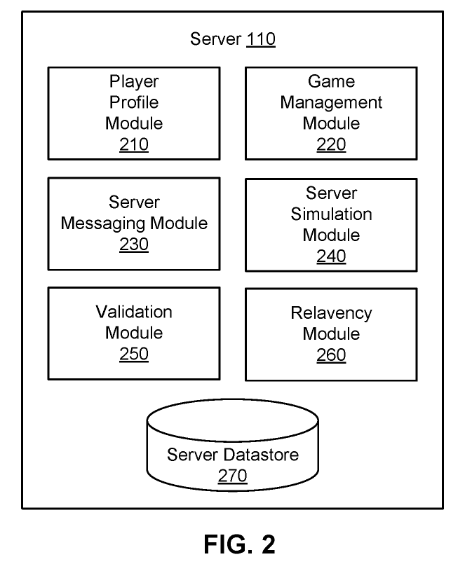

The server 110 is one or more computing devices that coordinate interactions between users and virtual environments. In one embodiment, the server 110 provides instances of virtual environments in which users participate in a multiplayer game. The server 110 provides coordination functionality such as matching users to interact in a virtual environment, providing users’ client devices 140 with data describing other users’ game actions in the virtual environment, and tracking game metrics such as player or team scores, etc. Additional details of various embodiments of the server 110 are described in greater detail below with reference to FIG. 2.

A client device 140 is a computing device with which a user interacts with a virtual environment. Example client devices include desktop computers, laptops, gaming consoles, tablets, smartphones, and the like. In one embodiment, the virtual environment is the setting for a multiplayer game. The user may control a character in the game as well as the rotation of a virtual camera around the user’s character (e.g., a virtual camera having a fixed pitch angle and distance from the character that is always pointing at the character but can do so from any direction). Thus, the user has one degree of freedom of direct control over the camera (motion along a track surrounding the user’s character), meaning that for client devices 140 with limited input control options, more input controls are available for controlling the user’s character than if the user had greater freedom to control motion of the camera.

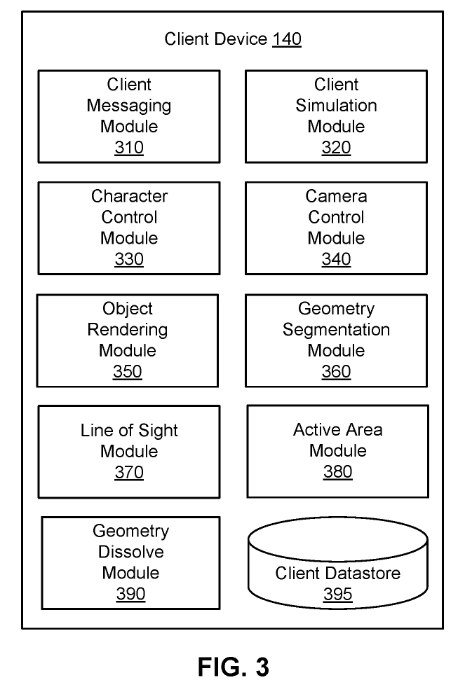

When aspects of the virtual environment such as walls, pillars, or other large objects (e.g., bookshelves, etc.) would obscure playable areas of the virtual environment that are viewable by the user’s character, those aspects may be “dissolved” (made to not be rendered or displayed on the client device 140) to enable the user to see the playable area that is visible to their character. Various embodiments of the client device 140 are described in greater detail below with reference to FIG. 3.

The network 170 provides the communication channels via which the other elements of the networked computing system 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

### EXAMPLE SYSTEMS

FIG. 2 illustrates one embodiment of the server 110 for an embodiment where the virtual environment is the setting for a multiplayer online game. In the embodiment shown, the server 110 includes a player profile module 210, a game management module 220, a server messaging module 230, a server simulation module 240, a validation module 250, a relevancy module 260, and a server datastore 270. In other embodiments, the server 110 includes different or additional elements. In addition, the functions may be distributed among the elements in a different manner than described.

The player profile module 210 manages profiles of players. In one embodiment, The player profile module 210 may interface with a client device 140 to enable a player to login to an account for the multiplayer game (e.g., by providing a username and password or other credentials). The account may include details (e.g., stored in the server datastore 270) of one or more characters that are playable by the player. For example, a player may have a playable character having one or more of a type or class, a skin, an outfit, equipment (e.g., weapons, armor, spells, potions, etc.), a level, one or more attributes or stats, and the like, all of which may be saved and developed from session to session (e.g., by earning or purchasing new equipment). A player’s account may also include statistics or other metrics tracking things such as the player’s total number of matches participated in, total time playing the game, performance within matches, favorite weapons and equipment, and the like.

The game management module 220 provides an interface to client devices 140 via which players can join instances of the game within the virtual environment (e.g., matches). In one embodiment, the game management module 220 matches players requesting to join an instance of the virtual environment with other players. Players may be matched based on profile data (e.g., players of approximately the same skill or game level, players in similar geographic regions, or players that otherwise having complementary profiles) or randomly. Additionally or alternatively, the game management module 220 may enable players to select which other players to play with (e.g., by providing a match code, sending invites to other players, etc.). In some embodiments, a player may create a new instance of the virtual environment, selecting properties for the virtual environment such as a map to use, a match length, or a match type, etc. When joining an instance of the virtual environment, players may be able to make selections for how they participate, such as selecting from a set of possible characters, choosing equipment to use, and choosing spells or potions to equip, etc.

Once players’ characters have entered the virtual environment, the server messaging module 230, server simulation module 240, validation module 250, and relevancy module 260 coordinate to provide a synchronized game experience in the virtual environment to the players at their client devices 140. The server messaging module 230 receives messages from client devices 140 over the network 170 indicating user inputs made by the players when interacting with local (to the corresponding client device) copies of the virtual environment. In one embodiment, the messages include inputs made by players at their client devices 140 along with times of the input (e.g., relative to a game clock or a synchronized system clock). Alternatively, the time of messages may be considered to be the time they are received by the server messaging module 230, which may add a timestamp.

The user inputs and times are passed to the server simulation module 240 which maintains a server copy of the virtual environment. The server simulation module 240 updates the state of the server copy of the virtual environment using the user inputs, which should synchronize the server copy with the local copies maintained by the client devices 140 (with regard to actions taken by players using the client devices). For example, if the user inputs indicate that the player’s character walked five meters forward and picked up an item, the copy of the virtual environment is updated by moving the player’s character five meters in the appropriate direction and changing the state of the item to indicate that the player’s character has picked it up (e.g., by adding it to an inventory and removing it from the virtual environment). The server simulation module 240 updates the state of the copy based on inputs received for all of the players interacting with the virtual environment. The server simulation module 240 may also update the state of the environment to reflect changes in dynamic objects. For example, a mechanical platform may periodically move from a first location to a second location without input from a player.

The validation module 250 verifies that actions taken by players received from the client devise are consistent with the server copy of the virtual environment and addresses conflicts as needed. For example, if two player’s characters attempt to pick up the same object at approximately the same time, the validation module 250 determines which player successfully picked up the item and sends an update to the client device 140 of the other player (e.g., via the server messaging module 230 over the network 170) to update that client device’s local copy of the virtual environment to indicate that the player’s character did not pick up the item.

The relevancy module 260 determines what aspects of the server copy of the virtual environment need to be sent to client devices 140. In one embodiment, the relevancy module 260 determines a portion of the virtual environment that is relevant to a client device 140 based on the location of the character or camera being controlled by that client device. In this context, relevant means updates to the virtual environment occurring within that portion (e.g., the actions of other players) could impact the gameplay of the player using the client device 140. This may be determined using any suitable technique, such as the portion: being a circle with a predetermined radius around the player’s character (or another shape centered on the player’s character), being parts of the virtual environment in the line of sight of the player’s character (or optionally in line of sight or within a predetermined distance of being in line of sight), being parts of the virtual environment that are in the current camera view (or optionally within a predetermined distance of being within the current camera view), or the like.

The relevancy module 260 sends updates to the determined portion of the virtual environment (e.g., via the server messaging module 230 and network 170) to the client device 140 for it to update its local copy of the virtual environment. Additionally or alternatively, whether other players’ actions are seen to a client device 140 may be determined based on evaluating whether that action can impact the view of the virtual world currently displayed at the client device. For example, an arrow being shot from the same location in one direction, away from the current view displayed at the client device 140 will not impact that view and may not be sent to the client device. Conversely, information on an arrow shot from the same location towards the portion of the virtual world currently displayed at the client device 140 may be sent to the client device 140 do it can be displayed passing through the player’s view of the virtual world. It should be appreciated that by sending relevant updates to the client devices 140, the local copies of the virtual world displayed at each client device can be synchronized to be consistent with the server copy of the virtual world without sending every update to every client device, thus reducing the bandwidth required to maintain effective synchronization of the copies of the virtual world at each client device.

The server datastore 270 is one or more non-transitory computer-readable media that store the data used by the other elements of the server 110. For example, player profiles, virtual world maps, and game state data may all be stored in the server datastore 270. Furthermore, although the server datastore 270 is shown as a single entity within the server 110, it should be appreciated that the data may be split across any number of computer-readable media at one or more locations. For example, player profiles may be stored remotely as part of a distributed database.

FIG. 3 illustrates one embodiment of a client device 140 suitable for enabling a player to interact with a virtual environment. In the embodiment shown, the client device 140 includes a client messaging module 310, a client simulation module 320, a character control module 230, a camera control module 340, an object rendering module 350, a geometry segmentation module 360, a line of sight module 370, an active area module 380, a geometry dissolve module 390, and a client datastore 395. In other embodiments, the client device 140 includes different or additional elements. In addition, the functions may be distributed among the elements in a different manner than described.

The client messaging module 310 manages communications between the client device 140 and the server 110. In one embodiment, the client messaging module receives update data for the virtual environment (e.g., as generated by the relevancy module 260) and provides it to the client simulation module 320 to update a local copy of the virtual environment for the client device 140. The client messaging module 310 may also capture user inputs provided by the user interacting with the virtual environment and provide representations of those user inputs to the server 110.

The client simulation module 320 maintains a local copy of the virtual environment that is synchronized with the server copy of the virtual environment (for at least the portion of the virtual environment in the vicinity of the user’s character) and thus also synchronized with the local copies of the virtual environment maintained by client simulation modules 320 of other client devices 140. In one embodiment, the client simulation module 320 receives updates to the state of the virtual environment from the server 110 and implements those updates in conjunction with any updates caused by user input using the client device 140 (e.g., actions taken by the user’s character). The client simulation module 320 may also make updates to the state of the virtual environment that are not driven by user inputs, such as the movement of mechanical platforms mentioned previously.

The character control module 330 processes user input to control the user’s character in the virtual environment. In one embodiment, a player may move their character through the playable area of the virtual environment and perform actions such as attacks, casting spells, using disposable items (e.g., potions), picking up items, and the like. The character control module 330 captures commands from the player to perform these movements and actions and passes them to the client simulation module 320 to update the local copy of the virtual world and the client messaging module 310 to provide the movements and action to the server 110 to update the server copy of the virtual world (and thus the local copies of the virtual world at client devices 140 of players with characters in the vicinity of the player’s character).

The camera control module 340 processes user input to control motion of the camera within the virtual environment. In one embodiment, the user can control the position of the camera with one degree of freedom. Specifically, the camera is placed at a predetermined height and angle relative to the ground. For example, if the characters in a game are considered to have standard human heights, the camera may be placed at a height between six and twelve meters and at an angle to the ground of 30 degrees to 60 degrees. The camera may be positioned a fixed distance from the user’s character (e.g., between five and twenty meters from the user’s character with the player only controlling rotation of the camera around the player’s character.

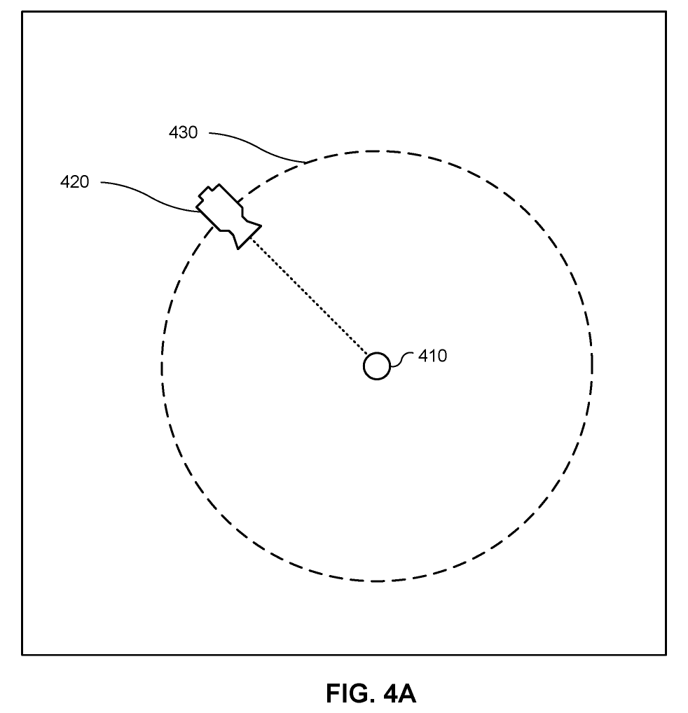

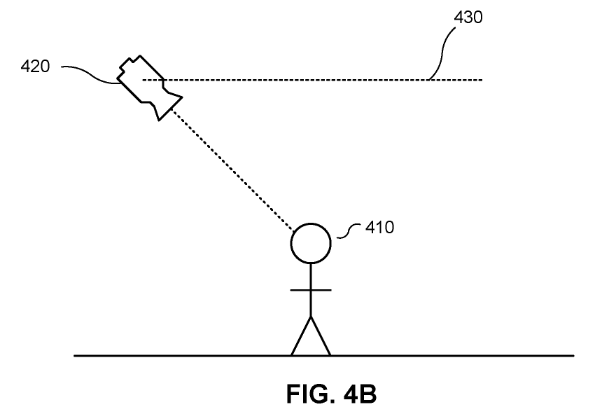

FIG. 4A illustrates this rotation of the camera 420 around a player’s character 410 in a top-down view of a game. The player can rotate the camera 420 around the character 410, essentially selecting its position on a circular track 430 centered on the character 410. The radius of the circular track 430 is the distance of the camera from the player’s character 410. FIG. 4B illustrates this motion of the camera 420 around the player’s character 410 from a side view. In this view, the track 430 of the camera 420 can be seen to be above the head of the player’s character 410 at a predetermined height. Because the camera motion is limited to a single degree of freedom, the number of input controls required for controlling the camera can be limited to two controls. For example, the left stick direction of a controller or left movement of a mouse may rotate the 420 camera counterclockwise around the player’s character 410 while the right stick direction of the controller or right movement of the mouse may rotate the camera 420 clockwise around the player’s character 410. It should be appreciated that this frees up other input controls to control aspects of the behavior player’s character 410 in the virtual environment (e.g., triggering different actions).

Referring back to FIG. 3, the object rendering module 350 determines how to render certain objects based on the position of the camera. In one embodiment, objects in the virtual environment that may be picked up by the user’s character are oriented such that they are always facing the camera. This aids in easy recognition of the object by the user. For example, an object may be located at a particular set of coordinates in the virtual environment. When those coordinates are in the camera view, the object rendering module may determine the direction from those coordinates to the camera and place a 3D representation of the object oriented such that a front face of the 3D object is pointing directly at the camera.

In one embodiment, a geometry segmentation module 360 segments the walls in the virtual environment into segments and then the line of sight module 370, active area module 380, and geometry dissolve module 390 coordinate to determine which segments to dissolve to ensure a player has an unobstructed view of relevant play space. In another embodiment, an area in which to consider dissolving walls is determined based on the location of a player’s character and pixels (or clusters of pixels) are evaluated individually to determine whether they should be dissolved. The area may be a cone that by default has its point a predetermined distance in front of the player’s character and extends around and behind the players with sides at predetermined angles. One or more sensors may extend from the player’s character to detect obstructions in the virtual environment and modify the position of the point of the cone or the angles of the spread of the cone based on detected obstructions. Thus, the distance of a sensor from the player’s character may be the smaller of the distance to the nearest obstruction and the maximum distance allowed for the sensor. Further details of both of these approaches are described in greater detail below. Although these modules are described in the context of a game environment, it should be appreciated that the same or similar techniques may be applied in other types of virtual environments.

The geometry segmentation module 360, where included, divides walls and other objects in the virtual environment into segments. Although the term “walls” is used for convenience, this should be understood to mean any aspects of the geometry of the virtual environment that may obscure a player’s view, such as walls, terrain, large furniture (e.g., bookshelves), and the like. In one embodiment, the geometry segmentation module 360 generates a point cloud from the walls and uses a greedy algorithm to identify contiguous wall segments. The geometry segmentation module 360 then divides the contiguous segments up into subsegments of a predetermined granularity. The geometry segmentation module 360 may use a fitting algorithm to fit a K-D tree in which each leaf node is a subsegment of the point cloud. The K-D tree may be arbitrarily aligned but constrained vertically.

The line of sight module 370 projects outwards from the player’s character’s location to determine portions of the virtual environment that are visible to the player’s character. In one embodiment, the active area module 380 projects this into a map of traversable space versus untraversable space in the virtual environment to identify a mask indicating traversable space that is in the line of sight of the player’s character. This mask indicates the active area of the virtual environment. The geometry dissolve module 390 uses ray tracing to project rays from the camera position and determines whether any of the active area is obscured by a wall segment. In one embodiment, the geometry dissolve module 390 dissolves any wall segment that is obscuring the active area. In this context, obscuring the active area may mean that any part of the active area is obscured by the wall segment or that at least a threshold amount of the active area is obscured by the wall segment.

Dissolving means that the display of the wall is changed such that the obscuring of the active area is reduced. In one embodiment, a wall segment is dissolved by replacing display of the full wall segment is the display of a stump that illustrates the footprint of the wall segment but has a small height (e.g., half a meter if the player’s character has the heigh of a typical human). Dissolving may occur immediately or use any suitable graphical effect, such as dissolving the wall segment from top to bottom over a predetermined time period (e.g., one second).

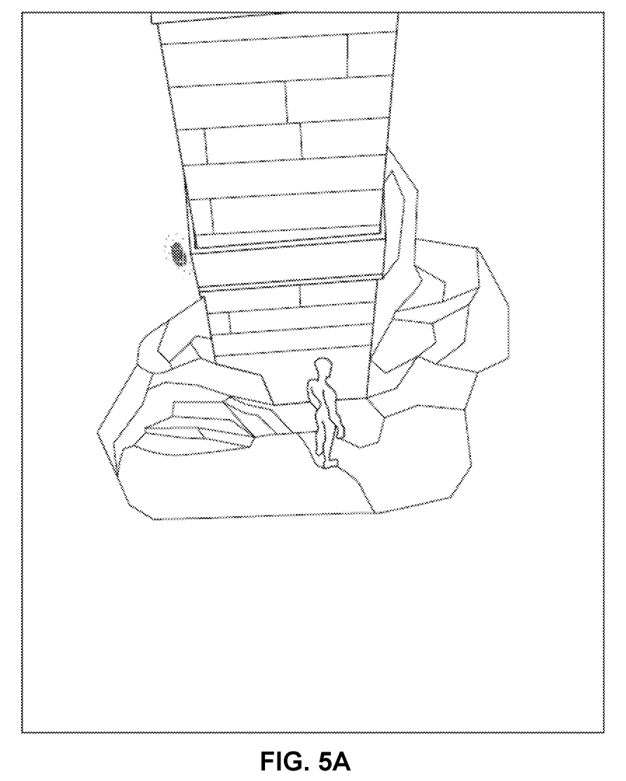

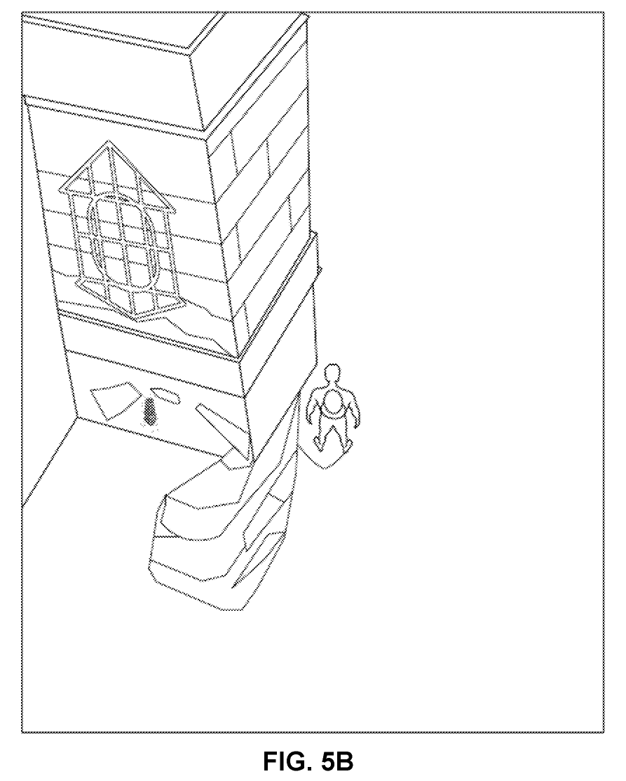

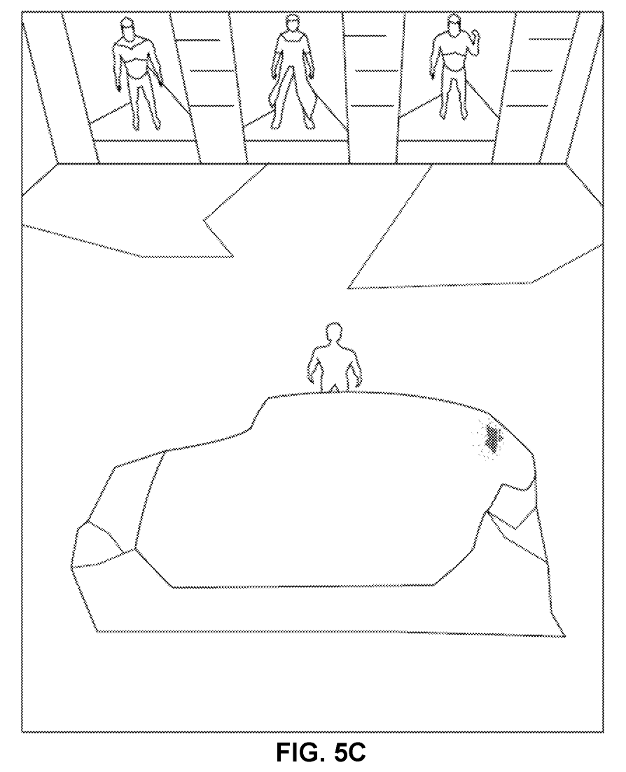

FIGS. 5A-5C illustrate an example wall dissolve process, according to one embodiment. In FIG. 5A, the player’s character is stood near a pillar (an example of a wall segment). The player’s character is on the same side of the pillar as the camera so the pillar is not dissolved. In FIG. 5B, the player was rotated the camera without moving their character. The player’s character is still on the same side of the pillar of the camera and does not have line of sight to any part of the virtual environment that is obscured by the pillar. Thus, the full pillar is still displayed, albeit from a different angle. In FIG. 5C, the player has rotated the camera further and the player’s character is now on the far side of the pillar from the camera. Thus, the player’s character has line of sight to parts of the virtual environment that would be obscured by the pillar were it to be rendered in full. Therefore, the pillar has been replaced by a stump that indicates the footprint of the pillar, but does not significantly obscure the player’s view of the active area on the far side of the pillar from the camera.

Using the combination the one degree of freedom camera control scheme and wall dissolve algorithm can provide various advantages over other approaches to displaying views of the virtual environment. As described previously, the use of a limited degrees of freedom camera control scheme reduces the number of input controls needed, freeing up available input controls for other purposes. Furthermore, where other approaches attempt to move the camera to avoid poor viewpoints (e.g., by sliding the camera along the outside of a wall rather than passing through it/going behind it), the wall dissolve algorithm means that the camera can remain at a consistent distance and pitch angle relative to the player’s character. Thus, assuming that the play space is flat (i.e., there is no variation in height such as stairs or ramps), this provides highly consistent views of the virtual environment for all players in all locations in the virtual environment and with all camera orientations.

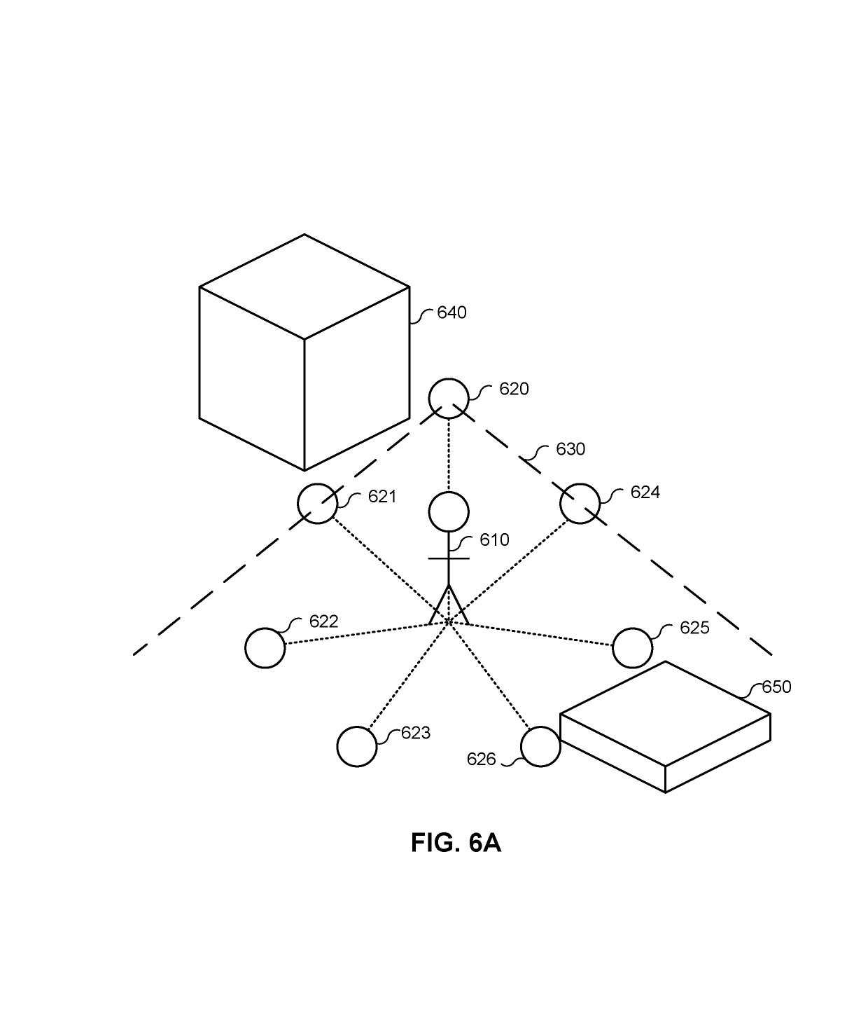

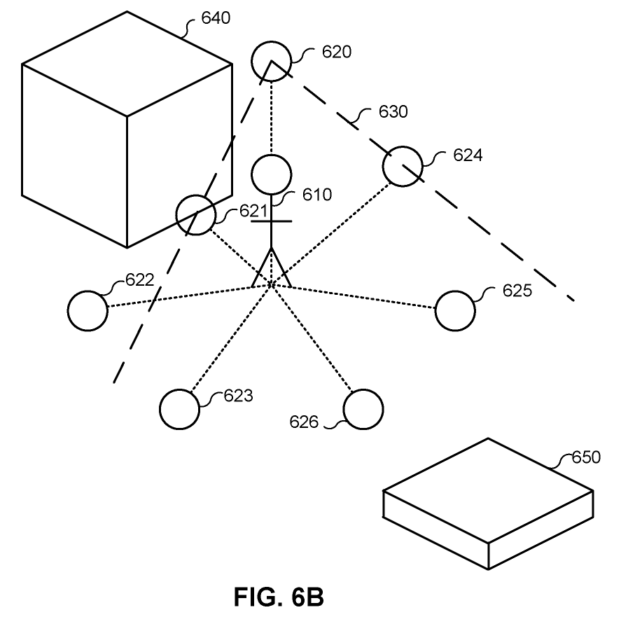

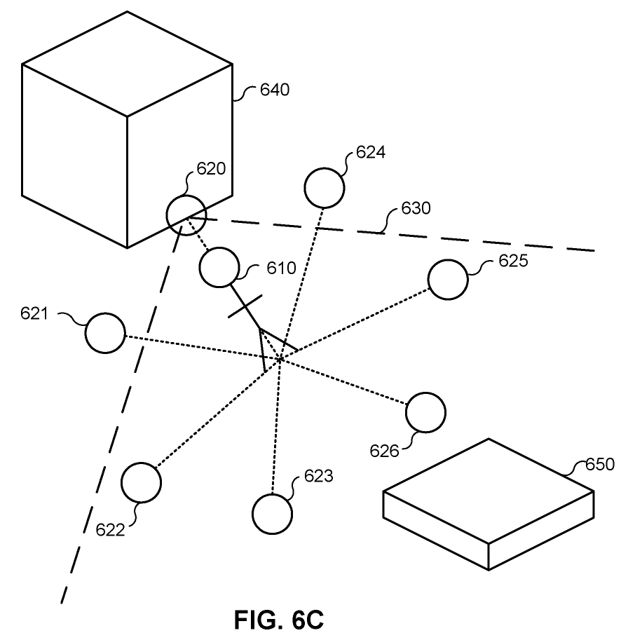

FIGS. 6A-C illustrate an example of the previously-described embodiment that uses an area in which pixels (or groups of pixels) are considered for being dissolved individually rather than initially segmenting the walls into predetermined segments. In FIG. 6A, a user’s character 610 is standing facing directly towards the top of the page. A first wall 640 is in front and to the left of the user’s character 610 and a second wall 650 is behind and to the right of the user’s character. An area 630 in which to consider dissolving walls is defined based on the position of the user’s character 610.

In the embodiment shown, the area 630 is a cone that is currently using default parameters such that the point of the cone is positioned a fixed distance in front of the user’s character 610. The point may also be positioned at a fixed height (e.g., the height used for the camera or a height above or below the camera height). The position of the point of the cone may be defined by a front sensor 620, which is currently at a maximum distance from the user’s character because there are no obstructions directly in front of the user’s character.

The central axis of the cone intersects a point on a line along the ground plane that passes directly under the point of the cone and through the user’s character 610. Typically, the intersection point will be behind the user’s character 610, but this need not be the case. Thus, the cone as a whole defines an ellipse or circle on the ground plane. The cone spreads out from the point to either side of and behind the user’s character 610 at an angle or angles determined based on obstructions in the vicinity of the user’s character 610.

In FIG. 6A, the user’s character is standing clear from any obstructions, so the cone spreads out at a default angle horizontally to either side of the user’s character (defined in this case by a front-left sensor 621 and a front-right sensor 624, that are both a maximum distance from the user’s character 610). The angles at which the cone expands to the left and right of the user’s character 610 may be different, based on detected obstructions, as described in greater detail below. The cone also spreads out vertically at a default angle, which may be same or different from the default angle used for expansion horizontally. Because the second wall 650 is within the area 630 defined by the cone, the second wall 650 is considered for dissolving. In this case, the second wall 650 is dissolved because it would otherwise block the user’s view of the area behind the second wall 650 that is visible to the user’s character 610 (e.g., as determined by ray tracing from the user’s character).

There may be additional sensors extending from the user’s character 610 to detect obstructions. In the illustrated example, there are four additional sensors: a left sensor 622, right sensor 625, a back-left sensor 623, and a back-right sensor 626, none of which are detecting obstructions and thus are a maximum distance from the user’s character. In the embodiment shown, the maximum distance for each sensor is the same, but some or all of the sensors may be assigned different maximum distances.

In FIG. 6B, the user’s character 610 has moved closer to the first wall 640. As a result, the front-left sensor 621 is detecting the first wall 640 and has been positioned closer to the user’s character 610 (as far away from the user’s character as the front-left sensor 621 may be positioned without being inside or passing through the first wall 640). As a result, the angle at which the cone expands on the left of the user’s character has been reduced such that the area 630 approximately follows the line of the first wall 640. The angle at which the cone expands to the right of the user’s character 610 is unaffected. Because the first wall 640 is outside of the area 630, it is not considered for dissolving, but the second wall 650, which remains within the area, is considered (and is dissolved as it is still obscuring part of the virtual environment that is visible to the user’s character 610). In one embodiment, if the front-left sensor 621 or front-right sensor 624 detects an obstruction, the other sensors on that side of the character (e.g., the left sensor 622 and back-left sensor 623 or the right sensor 625 and back-right sensor 626) may be used to further refine the positioning of the cone such that none of the obstruction is considered for dissolving. In contrast, if the front-left sensor 621 or the front-right sensor 624 do not detect an obstruction but the sensors further back do, the obstruction may not impact the cone at all as the obstruction may be blocking the view of the unobstructed area detected by the front-left and front-right sensors. Alternatively, the angles of the cone may be set such that any obstruction detected by any of the sensors is not within the cone, such that only walls behind the character and outside of the range of the sensors are considered for dissolving.

In FIG. 6C, the user’s character 610 has turned to directly face the first wall 640. As a result, the front sensor 620 has been positioned closer to the user’s character to avoid being inside of or passing through the first wall 640. Thus, the point of the cone defining the area 610 630 considered for wall dissolve has been moved closer to the user’s character 610 (approximately abutting the first wall 640). This prevents the first wall being considered for being dissolved, while the second wall 650 remains dissolved.

It should be appreciated that walls inside of the area 610 may not necessarily be dissolved. In one embodiment, each pixel of a wall in the area 610 is evaluated (to determine whether that pixel obscures a pixel that should be visible to the user’s character 610. For example, ray tracing may be performed from the pixel being considered for dissolving to determine whether there is an unobstructed line to any visible pixel (e.g., as indicated by active area mask generated by the active area module 380).

Additionally or alternatively, in some embodiments, once wall pixels have been dissolved, the now-visible (to the camera) pixels can be evaluated to determine whether they are outside of the dissolved surface (meaning pixels that are visible to the user’s character 610, or at least could be visible without the user’s character 610 passing through or going round the dissolved wall) or inside of the dissolved surface (meaning pixels that are not visible to the player’s character 610, or at least are not visible without the user’s character 610 passing through or going around the dissolved wall). For example, whether a pixel is inside or outside of the surface may be determined using a signed distance field. In one embodiment, pixels that are inside the surface defined by the wall are identified using the signed distance field by evaluating each pixel on a cut surface. The surface of the cut at can be efficiently evaluated by intersecting the cone described previously with the pixel's view ray. Pixels inside of the dissolved surface may be replaced with a visual fill effect, such as mist or shadow. This can prevent the wall dissolve feature being abused to enable users to see into areas of the virtual environment that should not be visible to them (because they are not visible to their character 610).

Furthermore, to prevent hard edges between parts of a wall that are dissolved and parts that are not, contiguous areas of pixels to be dissolved may be identified and a gradient or other effect used around the periphery of the contiguous areas. For example, transparency of dissolved pixels in the center of a contiguous region may be set to 100% and gradually decrease to zero at (or just outside of) the edge of the contiguous region. Alternatively, a visual effect such as mist or shadows may be applied around the edge of a dissolved region.

Referring back to FIG. 3, the client datastore 395 is one or more non-transitory computer-readable media that store the data used by the other elements of the client device 140. For example, the local copy of the virtual environment may be stored in the client datastore 395.

### EXAMPLE METHOD

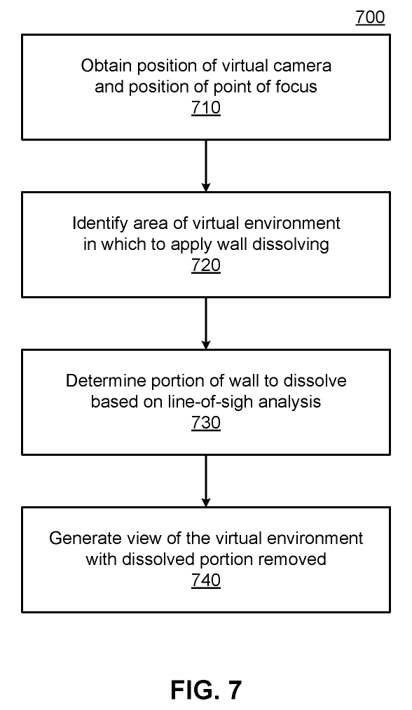

FIG. 7 illustrates an example method 700 for generating a view of a virtual environment with an obstructing wall (or other large object) removed, according to one embodiment. The steps of FIG. 7 are illustrated from the perspective of a client device 140 performing the method 700. However, some or all of the steps may be performed by other entities or components. In addition, some embodiments may perform the steps in parallel, perform the steps in different orders, or perform different steps.

In the embodiment shown, the method 700 begins with the client device 140 obtaining 710 the position of the virtual camera and the position of the point of focus. As described previously, these positions may be tied to each other, for example where the point of focus is the user’s character in the virtual environment and the user’s control of the virtual camera is limited to one degree of freedom control of the camera along a track that is a fixed distance from the user’s character at a fixed height and with a fixed angle relative to the ground plane of the virtual environment.

The client device 140 identifies 720 an area within the virtual environment in which to apply wall direction. In one embodiment, the area is defined by a cone that is positioned using a set of sensors that extend away from the point of focus to detect obstructions, as described above with reference to FIGS. 6A-C. Alternatively, the area may simply be the region around the point of focus (e.g., a circular active region of predetermined radius centered on the point of focus).

Regardless of how the area is identified 720, the client device 140 determines 730 whether to dissolve any wall portions. In one embodiment, for each pixel of one or more walls in the area for which wall dissolve is being applied, the client device 140 determines whether that pixel obstructs the view of the camera to a pixel (or other portion) of the virtual environment that is visible from the point of focus. Alternatively, the client device 140 may consider segments of walls and determine 730 to dissolve a segment if any part of the segment obscures the view of any part of the virtual environment that is within line-of-sight of the point of focus. Alternatively, the line-of-sight analysis may be used only to determine how the dissolve is performed, not whether dissolve is performed at all. For example, line-of-sight may be used on remaining pixels, after the wall pixels have been removed, to determine whether to color those pixels according to the color assigned to them in the virtual environment (for those pixels within line-of-sight) or using a fill effect, such as a shadow effect (for those pixels that are not within line-of-sight).

Once the wall dissolve algorithm has been applied, the client device 140 generates 740 a view of the virtual environment with the dissolved portions of walls removed. The client device 140 may display the generated 740 view of a screen, provide the view to the projector, or otherwise provide the view to the user in any appropriate way.

### COMPUTING SYSTEM ARCHITECTURE

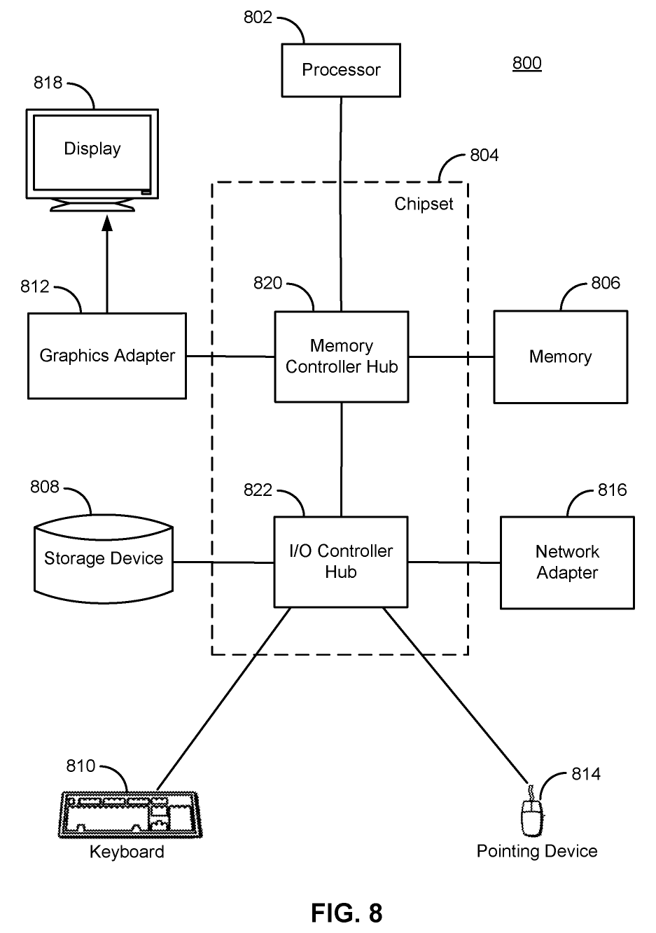

FIG. 8 is a block diagram of an example computer 800 suitable for use as a server 110 or client device 140. The example computer 800 includes at least one processor 802 coupled to a chipset 804. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. Other embodiments of the computer 800 have different architectures.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802. The pointing device 814 is a mouse, track ball, touchscreen, or other type of pointing device, and may be used in combination with the keyboard 810 (which may be an on- screen keyboard) to input data into the computer system 800. The graphics adapter 812 displays images and other information on the display 818. The network adapter 816 couples the computer system 800 to one or more computer networks, such as network 170.

The types of computers used by the entities of FIGS. 1-3 can vary depending upon the embodiment and the processing power required by the entity. For example, the server 110 might include multiple blade servers working together to provide the functionality described. Furthermore, the computers can lack some of the components described above, such as keyboards 810, graphics adapters 812, and displays 818.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/- 10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method of providing a view of a virtual environment, the computer-implemented method comprising:
obtaining a position of a virtual camera and a position of a point of focus;
identifying an area of the virtual environment in which to apply wall dissolving;
determining to dissolve a portion of a wall within the area based on a line-of-sight analysis to the point of focus; and
generating the view of the virtual environment with the portion of the wall removed.

2. The computer-implemented method of claim 1, wherein the position of the virtual camera is a user-controlled point on a track having a fixed positional relationship to the point of focus.

3. The computer-implemented method of claim 2, wherein the track is at a fixed height, a fixed distance from the point of focus, and at a fixed vertical angle relative to a ground plane of the virtual environment, with a field of view of the virtual camera including the point of focus.

4. The computer-implemented method of claim 1, wherein the point of focus is a position of a character in the virtual environment that is controlled by a user.

5. The computer-implemented method of claim 4, wherein the area is defined by a cone starting at point in front of the character and expanding towards and past the character according to one or more angles.

6. The computer-implemented method of claim 5, wherein the one or more angles include a first angle controlling expansion of the cone to a left side of the character and a second angle controlling expansion of the cone to a right side of the character.

7. The computer-implemented method of claim 5, wherein the point in front of the character is determined by a sensor that extends in front of the character to a position at which an obstacle is encountered as the sensor extends away from the character or a maximum distance, whichever is smaller.

8. The computer-implemented method of claim 5, wherein the one or more angles are determined by a plurality of sensors, the plurality of sensors including a first sensor that extends in a first direction on a left side of the character to a first position, the first position being where a first obstacle is encountered as the first sensor extends away from the character or a maximum distance, whichever is smaller, and a second sensor that extends in a second direction on a right side of the character to a second position, the second position being where a second obstacle is encountered as the second sensor extends away from the character or the maximum distance, whichever is smaller.

9. The computer-implemented method of claim 1, wherein the area is a portion of the virtual environment within a predetermined distance of the point of focus.

10. The computer-implemented method of claim 1, wherein the portion of the wall comprises a wall pixel and the line-of-sight analysis comprises ray tracing from the wall pixel to determine whether the wall pixel is between the virtual camera and a pixel that is within line-of-sight of the point of focus.

11. The computer-implemented method of claim 10, wherein the ray tracing uses a precalculated active area mask that indicates pixels within the virtual environment within line-of-sight of the focus point.

12. The computer-implemented method of claim 1, wherein generating the view of the virtual environment with the portion of the wall removed comprises:
removing pixels of the wall from consideration for being rendered in the view of the virtual environment;
identifying pixels visible in the view of the virtual environment that are inside a surface defined by the wall; and
replacing the identified pixels with a fill effect.

13. The computer-implemented method of claim 12, wherein identifying the pixels visible in the view of the virtual environment that are inside the surface defined by the wall comprises using a signed distance field evaluated at a cut surface to identify pixels inside the surface.

14. A non-transitory computer-readable storage medium comprising stored instructions for providing a view of a virtual environment, the instructions, when executed, causing a computing system to perform operations including:
obtaining a position of a virtual camera and a position of a point of focus;
identifying an area of the virtual environment in which to apply wall dissolving;
determining to dissolve a portion of a wall within the area based on a line-of-sight analysis to the point of focus; and
generating the view of the virtual environment with the portion of the wall removed.

15. The non-transitory computer-readable storage medium of claim 14, wherein the point of focus is a position of a character in the virtual environment that is controlled by a user, and the area is defined by a cone starting at point in front of the character and expanding towards and past the character according to one or more angles.

16. The non-transitory computer-readable storage medium of claim 15, wherein the one or more angles include a first angle controlling expansion of the cone to a left side of the character and a second angle controlling expansion of the cone to a right side of the character.

17. The non-transitory computer-readable storage medium of claim 15, wherein the point in front of the character is determined by a sensor that extends in front of the character to a position at which an obstacle is encountered as the sensor extends away from the character or a maximum distance, whichever is smaller.

18. The non-transitory computer-readable storage medium of claim 15, wherein the one or more angles are determined by a plurality of sensors, the plurality of sensors including a first sensor that extends in a first direction on a left side of the character to a first position, the first position being where a first obstacle is encountered as the first sensor extends away from the character or a maximum distance, whichever is smaller, and a second sensor that extends in a second direction on a right side of the character to a second position, the second position being where a second obstacle is encountered as the second sensor extends away from the character or the maximum distance, whichever is smaller.

19. The non-transitory computer-readable storage medium of claim 14, wherein the portion of the wall comprises a wall pixel and the line-of-sight analysis comprises ray tracing from the wall pixel to determine whether the wall pixel is between the virtual camera and a pixel that is within line-of-sight of the point of focus.

20. The non-transitory computer-readable storage medium of claim 14, wherein generating the view of the virtual environment with the portion of the wall removed comprises:
removing pixels of the wall from consideration for being rendered in the view of the virtual environment;
identifying, using a signed distance field evaluated at a cut surface, pixels visible in the view of the virtual environment that are inside a surface defined by the wall; and
replacing the identified pixels with a fill effect.
